(19) United States
(12) Patent Application Publication
(10) Pub. No.: US 2011/0127474 A1
(43) Pub. Date: Jun. 2, 2011

(54) STAPLE REMOVER

(75) Inventor: SANE-TUE CHEN, Chang Hua (TW)

(73) Assignee: ABEL INDUSTRIES INTERNATIONAL CO., LTD., Chang-Hua (TW)

(21) Appl. No.: 12/956,006

(22) Filed: Nov. 30, 2010

(30) Foreign Application Priority Data
Dec. 1, 2009 (TW) 098222461

(51) Int. Cl. B25C 11/00

(52) U.S. Cl. 254/28

(57) ABSTRACT

A staple remover includes: a fixed seat including a front end portion and a bottom surface; a staple removing blade including a tip disposed in the front end portion, and an elongate staple passing surface inclined relative to the bottom surface; a moving seat disposed pivotally on the fixed seat; a staple retracting unit including a staple retracting member movable relative to the staple removing blade and having a claw, and a first biasing member for biasing the claw to contact the staple passing surface; and a motion transmitting mechanism including a first member connected to the moving seat, and a second member connected to the claw. When the moving seat is pivoted relative to the fixed seat to convert from a non-pressed state to a pressed state, the claw is moved from an extended position to a retracted position.

### CROSS-REFERENCE TO RELATED APPLICATION

This application claims priority of Taiwanese application No. 098222461, filed on Dec. 1, 2009.

### BACKGROUND OF THE INVENTION

1. Field of the Invention

The invention relates to a staple remover, more particularly to a staple remover that has a capacity for receiving staples safely.

2. Description of the Related Art

A conventional staple remover, such as one shown in Japanese Patent Application Publication Number 2002-178274 or Japanese Utility Model Publication Number 5-88881, generally has a remover body extending along a longitudinal direction, a staple removing blade mounted on an inclined front end portion of the remover body, and a sliding member mounted movably on the remover body and including a pair of claws abutting against the staple removing blade such that, when a user holds the remover body and moves the staple remover forwardly toward a staple on a paper surface, the staple removing blade is driven to pull the staple upwardly from the paper surface, and thereafter, when the user moves the sliding member rearwardly, the claws pulls off and carries the staple for subsequent reception in the remover body.

However, the area of the sliding member for the user to exert a force is rather small, and the user has to use a finger (such as a thumb or a second finger) awkwardly so that the sliding member can be pushed rearwardly along the longitudinal direction. As such, this sort of staple remover is inconvenient to use in practice.

### SUMMARY OF THE INVENTION

Therefore, the object of the present invention is to provide a staple remover that is easy to use and that is capable of receiving staples safely.

According to the present invention, the staple remover comprises a fixed seat, a staple removing blade, a moving seat, a staple retracting unit and a motion transmitting mechanism. The fixed seat includes a front end portion and a bottom surface, and defines a staple receiving space. The staple receiving space is adapted to receive staples, and has a front opening directed toward the front end portion. The staple removing blade is disposed on the front end portion, and includes a tip disposed in front of the front end portion, and a staple passing surface inclined relative to the bottom surface and extending along an axis. The moving seat is disposed pivotally on the fixed seat, and is convertible between a non-pressed state and a pressed state. The staple retracting unit is disposed between the fixed seat and the moving seat, and includes a staple retracting member movable relative to the staple removing blade, and is formed with at least one claw, and a first biasing member disposed between the staple retracting member and the fixed seat for biasing the claw into contact with the staple passing surface. The claw is movable relative to the staple passing surface between an extended position disposed in proximity to the tip, and a retracted position disposed in proximity to the front opening. The motion transmitting mechanism is disposed between the fixed seat and the moving seat, and includes a first member connected to the moving seat, and a second member connected to the staple retracting member and driven by the first member. When the moving seat is pivoted relative to the fixed seat to convert from the non-pressed state to the pressed state, the claw of the staple retracting member is moved from the extended position to the retracted position.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of the preferred embodiment of a staple remover according to the present invention;

FIG. 2 is an exploded perspective view of the preferred embodiment;

FIG. 3 is a sectional side view of the preferred embodiment;

FIG. 4 is a fragmentary perspective view of the preferred embodiment;

FIG. 5 is a view similar to FIG. 1 but illustrating that a staple removing blade is operated to remove a staple;

FIG. 6 is a view similar to FIG. 3 but illustrating that the staple has been moved past claws of a staple retracting member;

FIG. 7 is a view similar to FIG. 5 but illustrating that a moving seat is depressed;

FIG. 8 is a view similar to FIG. 6 but illustrating that each of the claws of the staple retracting member is moved to a retracted position whereat the staple is received in a staple receiving space; and

FIG. 9 is a side view of the preferred embodiment for illustrating another operational manner of the staple remover.

### DETAILED DESCRIPTION OF THE PREFERRED EMBODIMENT

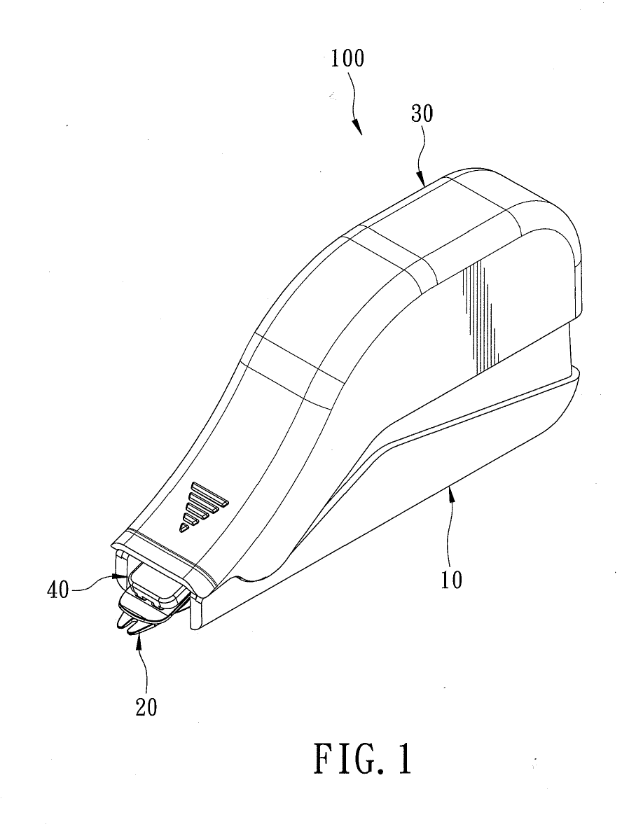

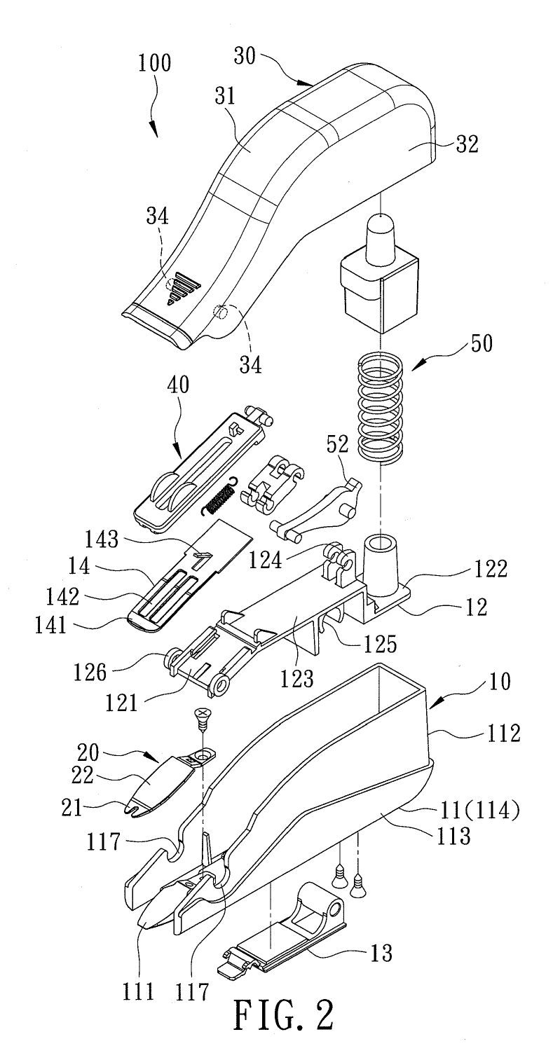

Referring to FIGS. 1 and 2, the preferred embodiment of a staple remover 100 according to the present invention is shown to include a fixed seat 10, a staple removing blade 20, a moving seat 30, a staple retracting unit 40 and a motion transmitting mechanism 50.

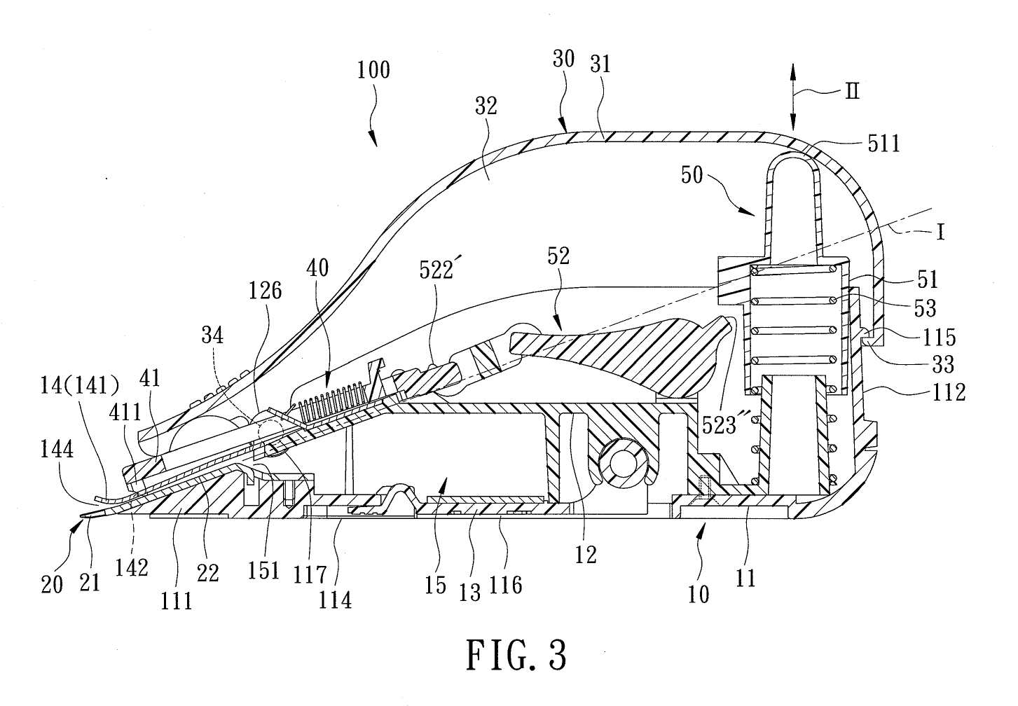

As shown in FIGS. 2 and 3, the fixed seat 10 includes an outer piece 11, an inner piece 12 disposed fixedly within the outer piece 11, a cover 13 disposed pivotally on the inner piece 12, and a guiding plate 14 mounted on the inner piece 12. The outer piece 11 and the inner piece 12 cooperate to define a staple receiving space 15.

The outer piece 11 has a front end 111, a rear end surface 112, a pair of grasping side surfaces 113 spaced apart from each other and exposed outwardly of the moving seat 30, a bottom surface 114 connected between the grasping side surfaces 113, a position-limiting block 115 formed on the rear end surface 112, a bottom opening 116 extending through the bottom surface 114 and disposed in spatial communication with the staple receiving space 15, and a pair of insert grooves 117 each having an top end opening. In this embodiment, the staple receiving space 15 has a front opening 151 directed toward the front end 111.

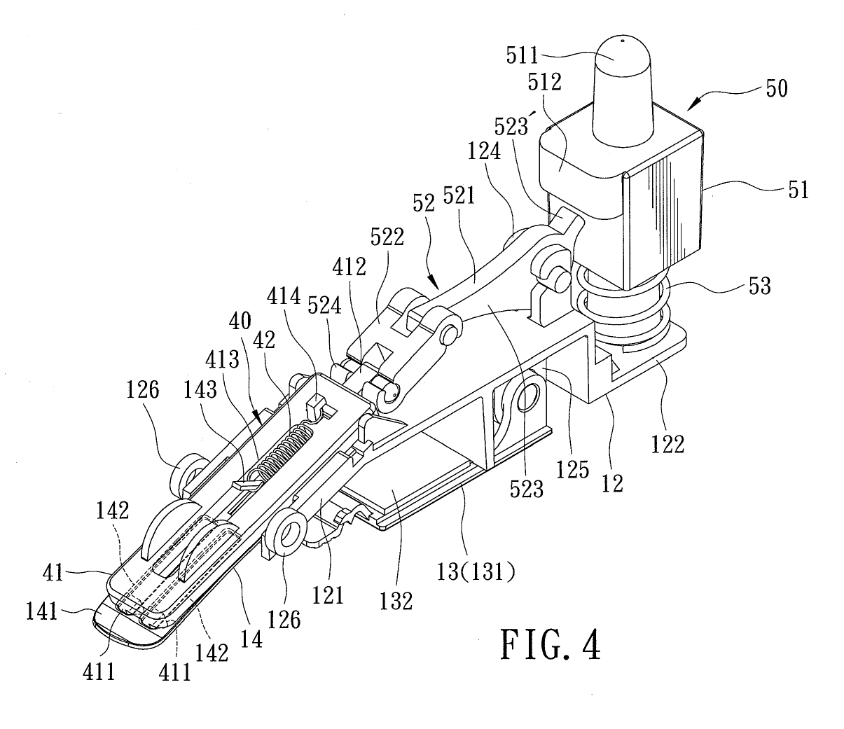

As shown in FIGS. 2 and 4, the inner piece 12 includes a front inclined end portion 121, a rear end portion 122 fastened to the outer piece 11, a middle section 123, a pair of upper pivot lugs 124 extending upwardly from the middle section 123, a lower pivot lug 125 extending downwardly from the middle section 123, and a pair of front pivot lugs 126 disposed at the front inclined end portion 121 for engaging the insert grooves 117, respectively.

As shown in FIGS. 3 and 4, the cover 13 includes a cover body 131 mounted pivotably to the lower pivot lug 125 of the inner piece 12 for covering the bottom opening 116, and a magnetic member 132 disposed on an inner side of the cover body 131. The cover body 131 can be operated to open and close relative to the outer piece 11.

The guiding plate 14 is disposed on the front inclined end portion 121 of the inner piece 12, and extends toward the staple removing blade 20. In this embodiment, the guiding plate 14 is inclined relative to the bottom surface 114 and disposed on and above the staple removing blade 20.

As shown in FIGS. 2 and 3, the staple removing blade 20 is disposed on the front end portion 111 of the outer piece 11, and includes a tip 21 disposed in front of the front end portion 111, and a staple passing surface 22 inclined relative to the bottom surface 114 and extending along an axis (I). In this embodiment, the guiding plate 14 includes a front nose 141 disposed proximity to the tip 21, and a pair of guiding slots 142 each extending in a direction parallel to the axis (I), and an engaging block 143 extending inclindedly. The front nose 141 has a front end spaced apart from the tip 21 by a clearance 144.

The moving seat 30 is disposed pivotally on the inner piece 12 of the fixed seat 10, and includes a top wall 31, a pair of lateral walls 32 extending downwardly form opposite lateral edges of the top wall 31, a stop block 33 extending from a bottom edge of a rear end of the top wall 31 and registered with the position-limiting block 115, and a pair of aligned pivot shafts 34 extending respectively from inner sides of front ends of the lateral walls 32 toward each other. Each of the pivot shafts 34 is supported rotatably by a respective one of the front pivot lugs 126. The stop block 33 is disposed under the position-limiting block 115.

The moving seat 30 is convertible between a non-pressed state and a pressed state. When the moving seat 30 is in the non-pressed state, the stop block 33 is in contact with the position-limiting block 115.

As shown in FIGS. 3 and 4, the staple retracting unit 40 is disposed between the fixed seat 10 and the moving seat 30, and includes a staple retracting member 41 movable relative to the staple removing blade 20, and a first biasing member 42 disposed between the staple retracting member 41 and the guiding plate 14.

The staple retracting member 41 has a front end formed with a pair of claws 411, a rear pivot end 412, a slot 413 disposed between the claws 411 and the rear pivot end 412, and a holding block 414 disposed in proximity to the rear pivot end 412. In this embodiment, the guiding slots 142 of the guiding plate 14 are aligned respectively with the claws 411. The claws 411 extend through the guiding slots 142 to contact the staple passing surface 22.

In this embodiment, the first biasing member 42 is a tension spring that extends within the slot 413, and has two ends connected respectively to the engaging block 143 and the holding block 414. The first biasing member 42 biases the claws 411 to contact the staple passing surface 22.

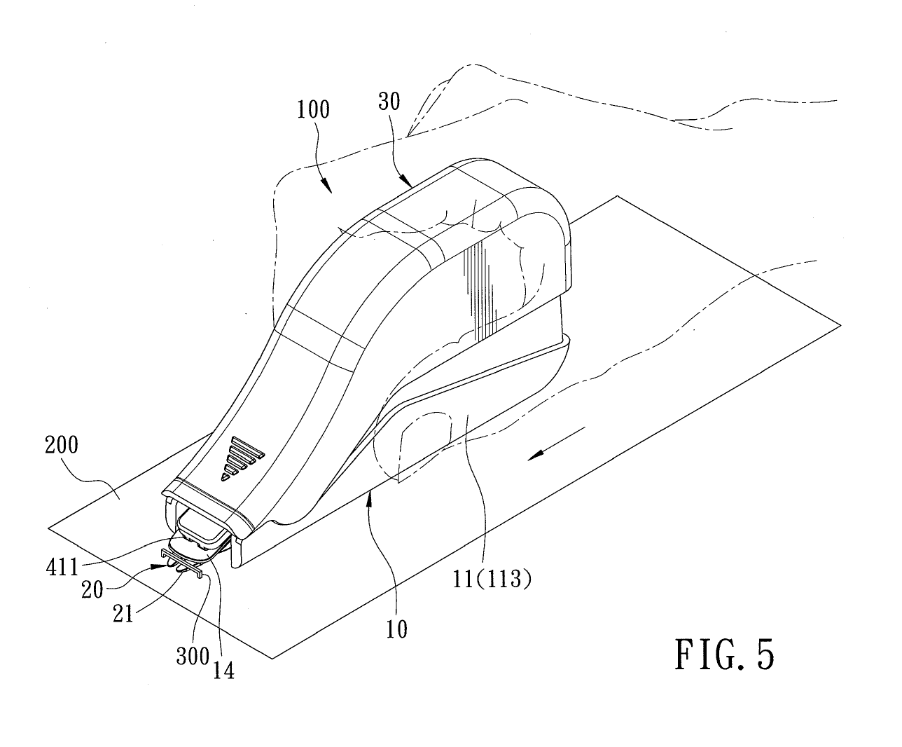

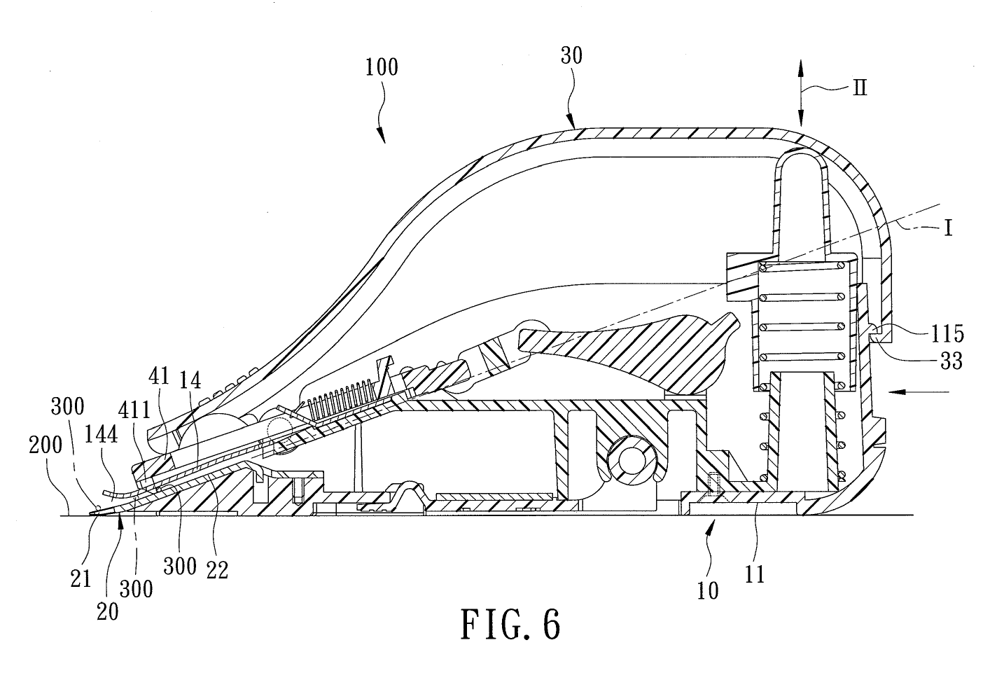

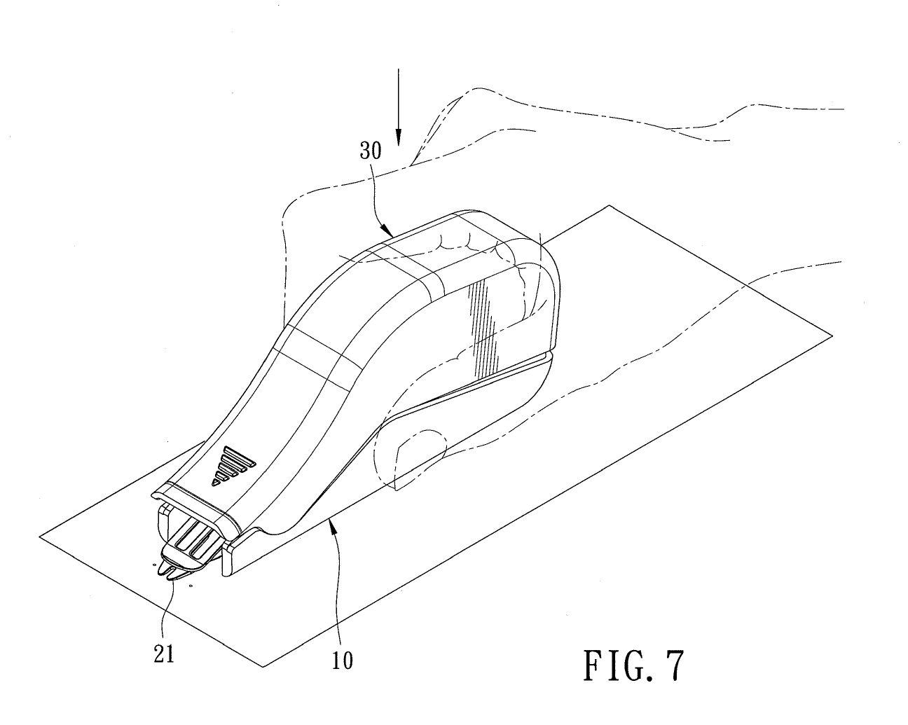

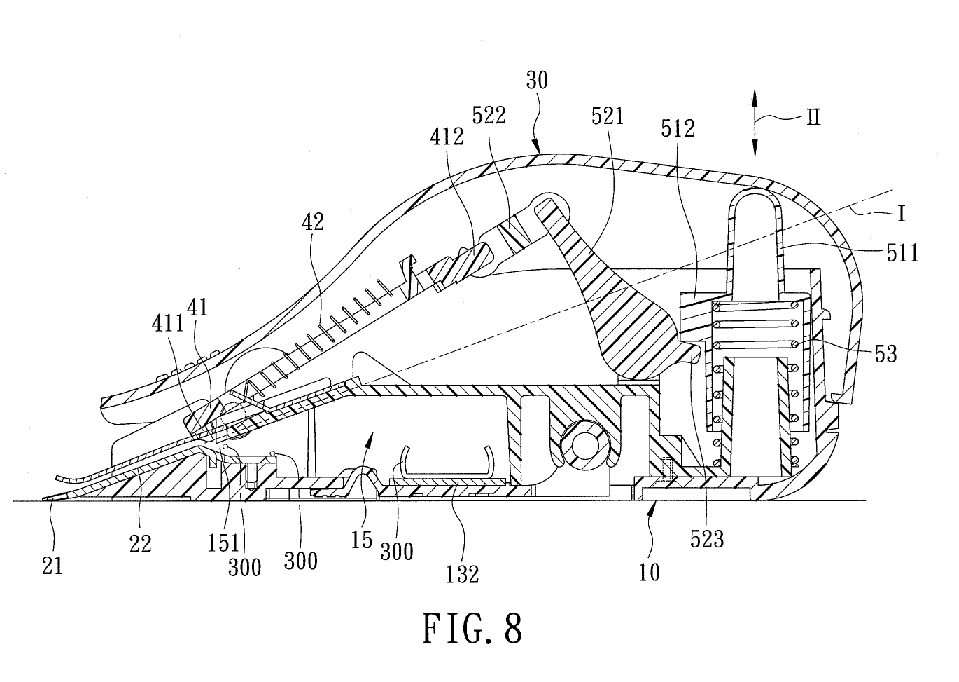

Each of the claws 411 of the staple retracting member 41 is movable relative to the staple passing surface 22 along the axis (I) from an extended position in proximity to the tip 21 (as shown in FIGS. 5 and 6) to a retracted position in proximity to the front opening 151 (as shown in FIGS. 7 and 8).

As shown in FIGS. 3 and 4, the motion transmitting mechanism 50 is disposed between the fixed seat 10 and the moving seat 30, and includes a first member 51 connected to the moving seat 30, a second member 52 connected to the staple retracting member 41 and driven by the first member 51, and a second biasing member 53 disposed between and abutting against the first member 51 and the rear end portion 122 of the inner piece 12.

The first member 51 is movable on the rear end portion 122 of the inner piece 12 in a height direction (II), and has a top end 511 biased to contact the top wall 31 of the moving seat 30 by the second biasing member 53, and a driving portion 512 extending toward the second member 52.

In this embodiment, the second member 52 is configured as a linkage, and has a driven end 523″ disposed under the driving portion 512 of the first member 51, and a front pivot end 522′ connected pivotally to the rear pivot end 412 of the staple retracting member 41, such that downward movement of the first member 51 results in movement of each of the claws 411 from the extended position to the retracted position.

The second member 52 includes a crank member 521 disposed pivotally on the fixed seat 10 and having a front crank arm 523 and a rear crank arm 523′ disposed behind the front crank arm 523, and a link 522 having a front end connected pivotally to the rear pivot end 412 of the staple retracting member 41 and constituting the front pivot end 522′ of the second member 52, and a rear end connected pivotally to the front crank arm 523 of the crank member 521. The rear crank arm 523′ has a rear end disposed under the driving portion 512 of the first member 51 and constituting the driven end 523″ of the second member 52.

With particular reference to FIGS. 5 and 6, when it is desired to use the staple remover 100 of this invention to remove a staple 300 attached on a paper surface 200, the staple remover 100 is first placed over the paper surface 200. Next, the user's fingers press against the grasping side surfaces 113, and the user's palm faces downwardly and moves into contact with the top wall 31 of the moving seat 30. In such a manner, when the staple remover 100 is moved forwardly toward the staple 300, the tip 21 of the staple removing blade 20 passes through the clearance between the staple 300 and the paper surface 200. Upon continued forward movement of the staple remover 100, the staple 300 enters a space between the staple passing surface 22 and the guiding plate 14 to thereby move along the staple passing surface 22 until it moves past the claws 411 of the staple retracting member 41. Hence, the staple 300 is disposed among the staple passing surface 22, the claws 411 and the guiding plate 14.

Subsequently, as shown in FIGS. 7 and 8, a depressing force is applied from the user's palm to the moving seat 30, so that the moving seat 30 is pivoted downwardly about the pivot shafts 34 to thereby convert from non-pressed state (as shown in FIG. 6) to the pressed state. During downward pivoting movement of the moving seat 30, the moving seat 30 moves the first member 51 downwardly in the height direction (II), so that the driving portion 512 of the first member 51 comes into contact with the driven end 523″ of the second member 52 to thereby rotate the crank member 521 clockwise. As a result, the link 522 pulls the rear pivot end 412 of the staple retracting member 41 rearwardly and upwardly, so as to move each of the claws 411 of the staple retracting member 41 over the staple passing surface 22 along the axis (I) from the extended position to the retracted position, thereby ultimately throwing the staple 300 from the front opening 151 into the staple receiving space 15 and allowing the staple 300 to be attracted by the magnetic member 132 for positioning the staple 300 within the staple remover.

When the user releases the moving seat 30, the second biasing member 53 biases the first member 51 to move upwardly to thereby return the moving seat 30 from the pressed state to the non-pressed state, so that the stop block 53 is moved to contact the position-limiting block 115. At the same time, the first biasing member 42 biases the staple retracting member 41 to move forwardly and downwardly so that each of the claws 411 of the staple retracting member 41 is moved back to the extended position (as shown in FIG. 6).

From the foregoing, the advantages of this invention can be summarized as follows:

1) By disposition of the motion transmitting mechanism 50 between the moving seat 30 and the staple retracting unit 40, the pivoting movement of the moving seat 30 can be converted into the movement of the claws 411 of the staple retracting member 41 along the axis (I), and in such a manner, a user can in use his or her palm to depress the moving seat 30 in a more ergonomic way, so as to drive the claws 411 of the staple retracting member 41 to remove the staple 300 with very slight effort, thereby receiving the staple 300 in the staple remover safety.

2) With respect to the area allowing for a force to be exerted, the moving seat 30 of this invention is much larger than the sliding member of the above-mentioned prior art. Thus, in comparison with the prior art, this invention is easier for a staple-removing operation than the prior art.

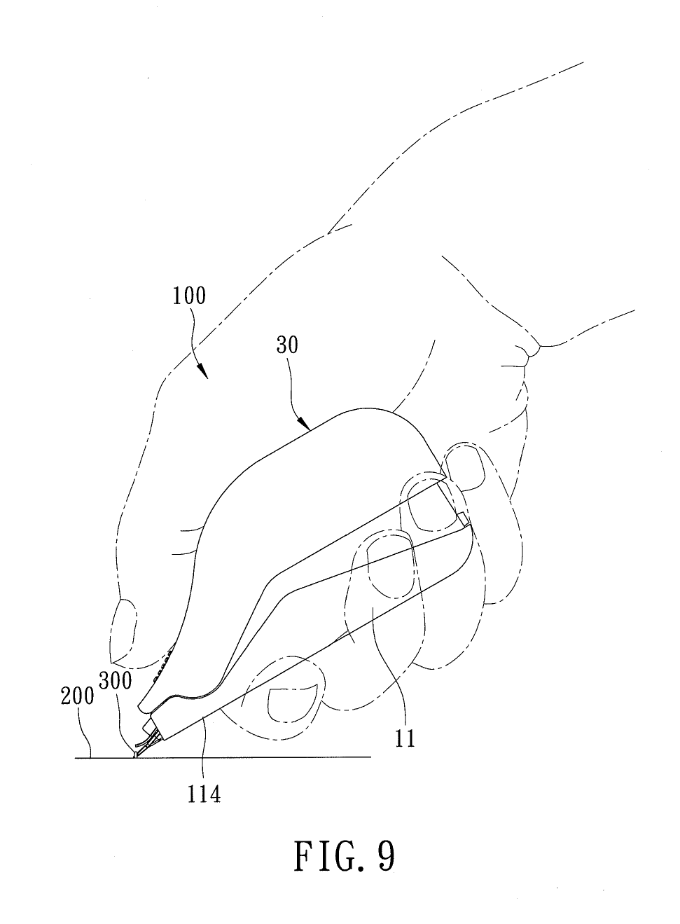

It is worth to mention that, as shown in FIG. 9, during the staple-removing operation, the user can as well grasp an assembly of the outer piece 11 and the moving seat 30, in such a manner that the bottom surface 114 is inclined relative to the paper surface 200. In this manner, the staple 3 can also be removed from the paper surface 200.

In view of the above, the staple 300 can be moved easily and safely into the staple remover 100. Thus, the object of this invention is achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A staple remover comprising:
a fixed seat including a front end portion and a bottom surface and defining a staple receiving space, said staple receiving space being adapted to receive staples and having a front opening directed toward said front end portion;
a staple removing blade disposed on said front end portion and including a tip disposed in front of said front end portion, and a staple passing surface inclined relative to said bottom surface and extending along an axis;
a moving seat disposed pivotally on said fixed seat and convertible between a non-pressed state and a pressed state;
a staple retracting unit disposed between said fixed seat and said moving seat and including a staple retracting member movable relative to said staple removing blade and formed with at least one claw, and a first biasing member disposed between said staple retracting member and said fixed seat for biasing said claw into contact with said staple passing surface, said claw being movable relative to said staple passing surface between an extended position disposed in proximity to said tip, and a retracted position disposed in proximity to said front opening; and
a motion transmitting mechanism disposed between said fixed seat and said moving seat and including a first member connected to said moving seat, and a second member connected to said staple retracting member and driven by said first member;
wherein, when said moving seat is pivoted relative to said fixed seat to convert from the non-pressed state to the pressed state, said claw of said staple retracting member is moved from the extended position to the retracted position.

2. The staple remover as claimed in claim 1, wherein said fixed seat further includes a guiding plate inclined relative to said bottom surface and disposed on and above staple removing blade, said guiding plate including a front nose disposed proximity to said tip, and a guiding slot that extends in a direction parallel to the axis and that is aligned with said claw of said staple retracting member, said front nose having a front end spaced apart from said tip by a clearance, said claw extending through said guiding slot to contact said staple passing surface.

3. The staple remover as claimed in claim 2, wherein said fixed seat further includes an outer piece and an inner piece disposed within said outer piece, said outer piece having a front end constituting said front end portion of said fixed seat, said outer piece having a bottom surface constituting said bottom surface of said fixed seat, said staple receiving space being defined between said inner and outer pieces, said guiding plate being disposed on said inner piece and extending toward said staple removing blade.

4. The staple remover as claimed in claim 3, wherein said fixed seat further includes a cover disposed pivotally on said inner piece, said outer piece being formed with a bottom opening in spatial communication with said staple receiving chamber, said cover including a cover body for covering said bottom opening, and a magnetic member disposed on said cover body and adapted for attracting the staples received within said staple receiving space.

5. The staple remover as claimed in claim 2, wherein said fixed seat further includes two opposite grasping side surfaces exposed outwardly of said moving seat, said bottom surface being disposed between said grasping side surfaces.

6. The staple remover as claimed in claim 1, wherein said staple retracting member further including a front end provided with said claw, and a rear pivot end opposite to said front end, said first member being movable on said fixed seat in a height direction and having a top end biased to contact said moving seat, and a driving portion extending toward said second member, said second member being configured as a linkage and having a driven end disposed under said driving portion of said first member, and a front pivot end connected pivotally to said rear pivot end of said staple retracting member, such that movement of said first member can result in movement of said claw from the extended position to the retracted position.

7. The staple remover as claimed in claim 6, wherein said second member includes a crank member disposed pivotally on said fixed seat and having a front crank arm and a rear crank arm disposed behind said front crank arm, and a link having a front end connected pivotally to said rear pivot end of said staple retracting member and constituting said front pivot end of said second member, and a rear end connected pivotally to said front crank arm of said crank member, said rear crank arm having a rear end disposed under said driving portion of said first member and constituting said driven end of said second member.

8. The staple remover as claimed in claim 6, wherein said motion transmitting mechanism further includes a second biasing member disposed between and abutting against said first member and said fixed seat for biasing said top end of said first member to move upwardly to contact said moving seat.

9. The staple remover as claimed in claim 8, wherein:
said fixed seat has a rear end surface, and a position-limiting block formed on said rear end surface; and
said moving seat is formed with a stop block biased by said second biasing member to contact said position-limiting block, so as to maintain said moving seat in the non-pressed state.
